(19) United States
(12) Patent Application Publication
(10) Pub. No.: US 2011/0181497 A1
(43) Pub. Date: Jul. 28, 2011

(54) OBJECT RELATED AUGMENTED REALITY PLAY SYSTEM

(76) Inventor: Roni Raviv, Nes Ziona (IL)

(21) Appl. No.: 12/693,463

(22) Filed: Jan. 26, 2010

(51) Int. Cl. G09G 5/00

(52) U.S. Cl. 345/8

(57) ABSTRACT

An augmented reality (AR) system including a head mounted display (HMD), the HMD including an optics module for generating an image and projecting a beam of the image on a display substrate, an object including a signal source for transmitting an activation signal related to the object, and a receiver/processor operative to receive and process the activation signal and to cause the optics module to generate virtual images related to the object in accordance with the activation signal.

### FIELD OF THE INVENTION

The present invention relates generally to augmented reality (AR) systems.

### BACKGROUND OF THE INVENTION

Augmented Reality (AR) is a technology that involves the overlay of computer graphics/images on the real world. In general, AR systems may include a see-through display that combines real and virtual images, an audio system that combines real and virtual sounds, and a system for placing the virtual images in relation to the real world.

There are wearable computing and AR systems in the prior art that use orientation trackers based on geomagnetic and/or inertial sensors. They allow enough control to look around the virtual environment and fly through it, but they do not enable the “reach-out-and-grab” interactions that make virtual environments so intuitive and which are needed to facilitate computer interaction.

U.S. Pat. No. 7,301,648 to Foxlin describes a “sourceless” tracking technique, that is, a technique that can be used anywhere with no set-up of a source, yet which claims to have a wider range of virtual environment-style navigation and interaction techniques than a simple head-orientation tracker, including manual interaction with virtual objects. The sourceless head orientation tracker is combined with a head-worn tracking device that tracks a hand-mounted 3D beacon relative to the head.

An example is that of a user wearing a portable VR tennis game or training system. The user holds a tennis racquet, to which are attached inertial sensors and ultrasonic transducers. The signals from the inertial sensors are processed by a first algorithm, such as a drift-corrected inertial orientation tracking algorithm, to obtain a sourceless measurement of the head orientation. In addition, the signals from the hand-mounted inertial sensors and the head-mounted inertial sensors are jointly processed to track both the position and orientation of the hand relative to the head, using a suitable algorithm. In this manner, the system coordinates virtual hitting of a tennis ball with the racquet.

### SUMMARY OF THE INVENTION

The present invention seeks to provide a novel augmented reality system, as is described more in detail hereinbelow.

There is thus provided in accordance with an embodiment of the present invention an augmented reality (AR) system including a head mounted display (HMD), the HMD including an optics module for generating an image and projecting a beam of the image on a display substrate, an object including a signal source for transmitting an activation signal related to the object, and a receiver/processor operative to receive and process the activation signal and to cause the optics module to generate virtual images related to the object in accordance with the activation signal. The signal source can be an active or passive signal source.

In accordance with an embodiment of the present invention an audio system is provided operative to combine real and virtual sounds related to the object in accordance with the activation signal.

### BRIEF DESCRIPTION OF THE DRAWINGS

The present invention will be understood and appreciated more fully from the following detailed description taken in conjunction with the drawings in which:

FIG. 1 is a simplified pictorial illustration of an object-related augmented reality (AR) system that employs a head mounted display (HMD), constructed and operative in accordance with an embodiment of the present invention;

FIG. 2 is a simplified block diagram of interaction between the object and the AR system, in accordance with an embodiment of the present invention; and

FIGS. 3-8 are simplified pictorial illustrations of different applications of the AR system in accordance with embodiments of the present invention, wherein:

FIG. 3 is an embodiment of a toy with interactive action figures;

FIG. 4 is an embodiment with interactive toy cars;

FIG. 5 is an embodiment with an interactive story book;

FIG. 6 is an embodiment with an interactive virtual pet;

FIG. 7 is an embodiment with an interactive doll; and

FIG. 8 is an embodiment with an interactive medical kit.

### DETAILED DESCRIPTION OF EMBODIMENTS

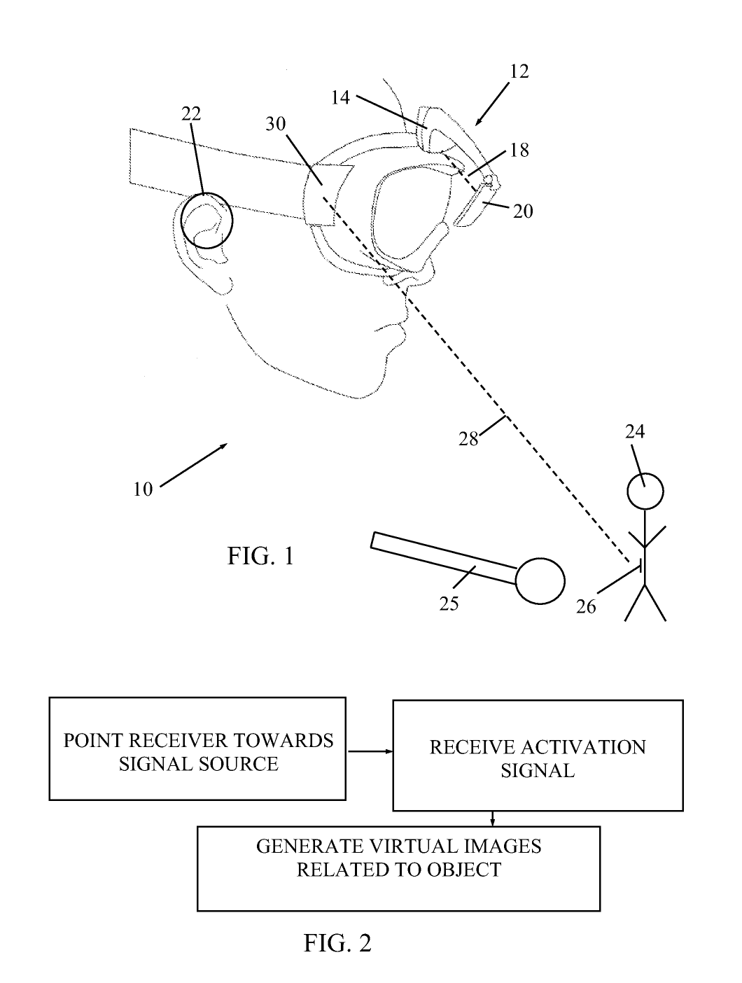

Reference is now made to FIG. 1, which illustrates an object-related augmented reality (AR) system 10 that employs a head mounted display (HMD) 12, constructed and operative in accordance with an embodiment of the present invention.

HMD 12 may be constructed as described in U.S. patent application Ser. No. 12/348,919 to Raviv, the disclosure of which is incorporated herein by reference. This HMD has an adjustable viewing distance; the HMD can set the image at any desired virtual distance, e.g., from 20 cm to infinity, and can thus place the image at a convenient viewing position which eliminates the need for refocus and delays associated therewith. The HMD uses a single display with immersive 3D augmented reality. The low cost system has full color with no limitation on resolution (resolution is dependent on LCD/OLED displays).

Briefly, HMD 12 includes a housing 14 in which is disposed an optics module 16. Optics module 16 may include a computer-generated imagery (CGI) system and suitable optical elements (lenses, mirrors, filters, LCD, OLED, etc.) for generating images and projecting a beam 18 of the images on a display substrate (also called display screen) 20. An audio system 22 is provided that can combine real and virtual sounds, such as from an audio database, microphone with user input, Internet connection and many more.

AR system 10 also includes an object 24 that includes a signal source 26. One family of signal sources includes an active signal source, such as but not limited to, a beacon, transmitter or transponder that transmits an activation signal 28. The signal transmission may be in any form, such as but not limited to, sonic, ultrasonic, any kind of electromagnetic wave (radio, infrared, visible light, etc.), active RFID tag, and other kinds of communication techniques. Another family of signal sources includes a passive signal source, such as but not limited to, a passive RFID tag, barcode or other readable code. The activation signal 28 is received and processed by a receiver/processor 30. For passive signal sources, the receiver/processor 30 “reads” the information and this information is also referred to as an activation signal 28. In accordance with the particular signal 28, the receiver/processor 30 instructs optics module 16 to generate virtual images related to the object 24. A hand-held object 25 in communication with receiver/processor 30 and/or optics module 16, such as a wand, may be used to interact with object 24.

It is noted that in contrast with the prior art, the present invention does not need inertial sensors, inertial orientation tracking systems or algorithms. The system of the invention is much simpler and is activated simply by the receiver/processor 30 being sufficiently aligned with signal source 26 so that the receiver can “read” or “receive” the signal 28. This greatly reduces the cost of the system.

The activation signal 28 can be a unique ID (identification) for object 24 (such as the car 40 or doll 70 below) which is personally recognizable, and the data/image/video generated is unique to that particular object.

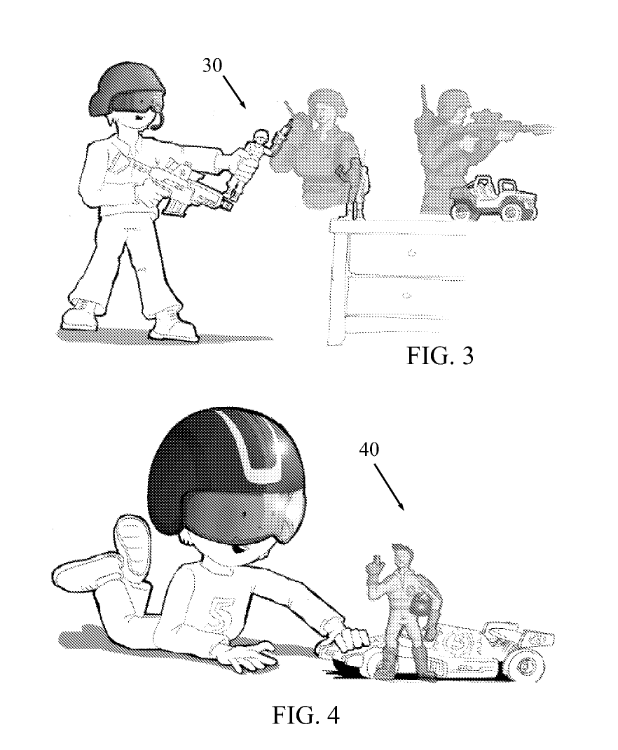

FIGS. 3-8 illustrate different applications of the AR system 10, in accordance with embodiments of the present invention, wherein the virtual images provide compelling, exciting visual and/or audio content related to the object as determined by the activation signal.

FIG. 3 is an embodiment of a toy 30 with interactive action figures. Each toy or figure has its own unique scene association activated by the activation signal. Images are manipulated by playing with the toy.

FIG. 4 is an embodiment with an interactive toy car 40. Images and sounds related to the car (race track, highway or race car driver, for example) come to life after activation by the activation signal. Images can be manipulated by the play pattern.

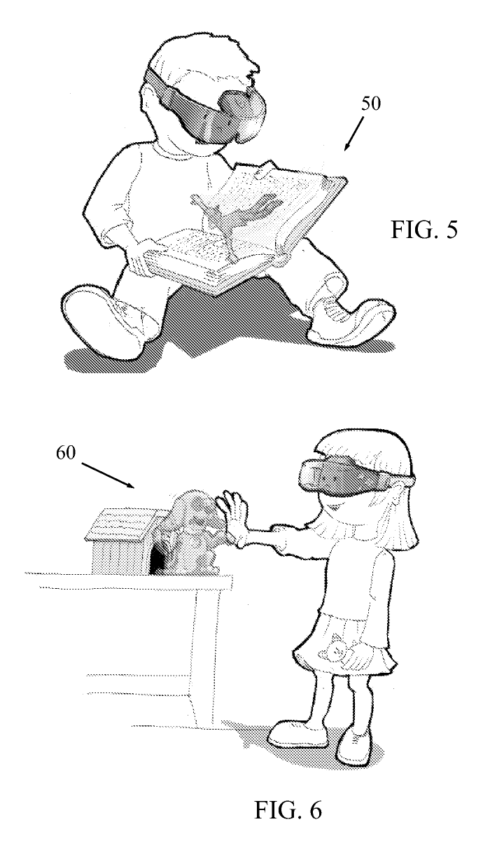

FIG. 5 is an embodiment with an interactive story book 50. Images and sounds related to the story come to life after activation by the activation signal (e.g., character in story “pops” out of the page).

FIG. 6 is an embodiment with an interactive virtual pet 60. Images and sounds related to the pet come to life after activation by the activation signal (e.g., pet responds to petting it).

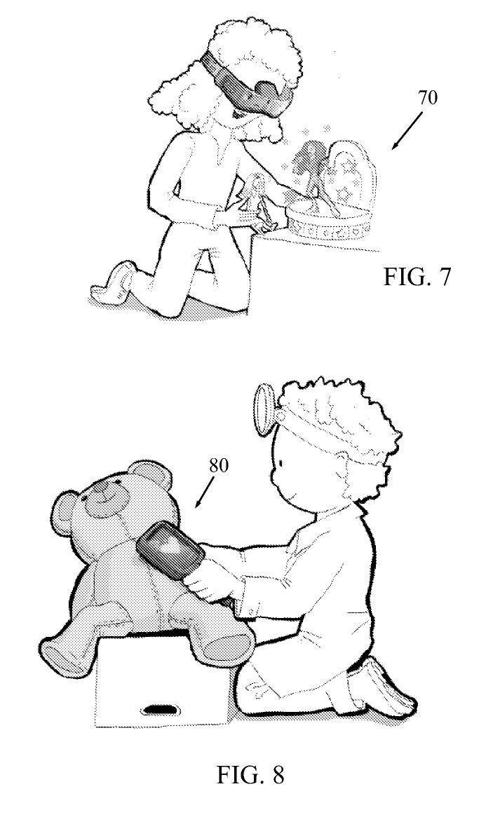

FIG. 7 is an embodiment with an interactive doll 70. Images and sounds related to the doll come to life after activation by the activation signal (e.g., doll sings and dances when viewed with headset; playing with the play set manipulates the virtual images).

FIG. 8 is an embodiment with an interactive medical kit 80. Images and sounds related to the kit come to life after activation by the activation signal. For example, a hand held instrument, such as an X-ray imager or machine scope, can be used to view internal organs or machine parts adjacent to the area investigated.

It will be appreciated by persons skilled in the art that the present invention is not limited by what has been particularly shown and described hereinabove. Rather the scope of the present invention includes both combinations and subcombinations of the features described hereinabove as well as modifications and variations thereof which would occur to a person of skill in the art upon reading the foregoing description and which are not in the prior art.

What is claimed is:

1. An augmented reality (AR) system comprising:
a head mounted display (HMD), said HMD comprising an optics module for generating an image and projecting a beam of said image on a display substrate;
an object comprising a signal source for transmitting an activation signal related to said object; and
a receiver/processor operative to receive and process said activation signal and to cause said optics module to generate virtual images related to said object in accordance with said activation signal.

2. The AR system according to claim 1, wherein said signal source is an active signal source.

3. The AR system according to claim 1, wherein said signal source is a passive signal source.

4. The AR system according to claim 1, further comprising an audio system operative to combine real and virtual sounds related to said object in accordance with said activation signal.

5. The AR system according to claim 1, wherein said signal source comprises a beacon.

6. The AR system according to claim 1, wherein said signal source comprises a transponder.

7. The AR system according to claim 1, wherein said signal source comprises a transmitter.

8. The AR system according to claim 1, wherein said signal source comprises an infrared signal source.

9. The AR system according to claim 1, wherein said signal source comprises an RFID tag.

10. The AR system according to claim 1, wherein said activation comprises a unique identification for said object which is personally recognizable, and said receiver/processor is operative to cause said optics module to generate images or data unique to said object.

11. The AR system according to claim 1, wherein said object comprises a toy.

12. The AR system according to claim 1, wherein said object comprises a vehicle.

13. The AR system according to claim 1, wherein said object comprises a storybook.

14. The AR system according to claim 1, wherein said object comprises a virtual pet.

15. The AR system according to claim 1, wherein said object comprises an interactive doll.

16. The AR system according to claim 1, wherein said object comprises an interactive medical kit.
